(19) United States
(12) Patent Application Publication
(10) Pub. No.: US 2005/0223310 A1
(43) Pub. Date: Oct. 6, 2005

(54) Displaying information from a portal website

(76) Inventors: Andre Wachholz-Prill, Bellheim (DE); Markus Kupke, Dielheim (DE)

Correspondence Address: FISH & RICHARDSON, P.C., PO BOX 1022, MINNEAPOLIS, MN, 55440-1022, US

(21) Appl. No.: 10/815,053

(22) Filed: Mar. 31, 2004

(51) Int. Cl. G06F 17/21; G06F 15/16

(52) U.S. Cl. 715/501.1; 715/513; 715/514; 709/219; 709/227; 709/203

(57) ABSTRACT

A web-based portal includes portal pages registered within a web-based architecture, and navigation options linked to different ones of the registered portal pages. A display of registered portal pages is provided as follows. A server provides, to an access device, information to provide a display of a selected first registered portal page that includes a hyperlink to a second registered portal page. The display of the page is provided within a displayed navigation framework that includes a navigation menu for user selection of navigation options. In response to receiving an input indicating user selection of the displayed hyperlink to the second page, the server provides to the access device 1) information to provide a display of the second registered portal page within the displayed navigation framework, and 2) information that causes the navigation menu to emulate a selection of a navigation option linked to the second registered navigation page.

### TECHNICAL FIELD

The disclosure relates to displaying information from a portal website.

### BACKGROUND

Generally, a portal is an Internet website that provides users with a starting point for accessing a vast array of resources and services. Portals typically can contain news, e-mail services, search engines, online shopping, chat rooms, discussion boards, as well as links to other web sites. The links and web pages designed for portals available on the Internet tend to reflect generic topics that are searched by users on the Internet.

The term “corporate portals” may be used to describe internal websites that provide proprietary information to employees, suppliers, and business partners. Corporate portals allow users to locate and share knowledge, participate in business processes, and provide collaboration services. Corporate portals generally provide search engines for identifying internal materials, as well as access to websites over the Internet. Typically, the links and pages provided by corporate portals fulfill the varied needs of users in an organization.

Generally, portals deliver resources and services to users through a software application known as a browser. The browser acts as an interface for sending web page display requests to the portal and for displaying resultant web pages received from the portal. Resultant web pages are displayed by the browser, which follows the navigation defined for the resultant web page.

The navigation provided by portals, however, may be disadvantageous and inefficient to a user because the context in which resources and services are displayed can vary from one web page to another. For example, selection of a hyperlink displayed on one web page may open a new window to display information content, whereas selection of a second hyperlink displayed on the same web page may result in either the replacement of currently displayed data content or, alternatively, replacement of a portion of currently displayed data content. As a result, users may become disorientated with respect to the multitude of navigation schemas provided by web portals. In addition, disorientation can occur in many other contexts, such as in selecting a navigation button provided by a web portal, typing a page address into an address field provided by the browser, and activating the “back” button of the browser, to name a few examples.

### SUMMARY

Techniques are disclosed for displaying information from a portal. The portal includes portal pages registered within a web-based architecture, and navigation options linked to different ones of the registered portal pages. The display of portal pages is provided within a displayed navigation framework that includes a navigation menu for user selection of menu options. The techniques can be used to provide information for the display of portal pages in the navigation framework and information that causes the navigation menu of the navigation framework to emulate a user selection.

For example, according to one aspect, a method for displaying a portal page registered within a web-based portal includes providing information for a display of a selected first registered portal page that includes a hyperlink to a second registered portal page. The display is provided within a displayed navigation framework that includes a navigation menu for user selection of navigation options. The method includes receiving an input indicating that a user has selected the displayed hyperlink to the second registered portal page and providing 1) information to display the second registered portal page within the displayed navigation framework, and 2) information that causes the navigation menu to emulate a selection of a navigation option linked to the second registered navigation page.

In another aspect, a method includes providing information to display a selected first registered portal page that includes a hyperlink to an unregistered portal page, wherein the display is provided within a displayed navigation framework that includes a navigation menu for user selection of navigation options. The method includes receiving an input indicating user selection of the displayed hyperlink and providing 1) information for a display of the selected unregistered web page and 2) information that causes the navigation menu to emulate a selection of a navigation option linked to a default navigation page.

According to another aspect, a method includes generating a portal page to be registered within a portal structure that includes portal pages registered within a portal framework and navigation options linked to different ones of the registered portal pages. The method includes assigning, for a portal page being generated, a service to be included in the portal page, and registering the portal page being generated and the service included in the portal page being generated with a run-time service.

A system, as well as articles that include a machine-readable medium storing machine-readable instructions for implementing the various techniques, are disclosed. Details of various implementations are discussed in greater detail below.

The details of one or more embodiments of the disclosure are set forth in the accompanying drawings and the description described below. Other features, objects, and advantages of the disclosure will be apparent from the description and drawings, and from the claims.

### BRIEF DESCRIPTION OF DRAWINGS

FIG. 1 is a block diagram of a networked computer system that allows for the display of web pages.

FIG. 2 illustrates an example architecture of a web-based portal.

FIG. 3 illustrates an example of defining target web pages for a web-based portal.

FIG. 4 illustrates an example of defining a structure of target-web pages for a web-based portal.

FIG. 5 illustrates an example of assigning services to target web pages.

FIG. 6 is a flowchart of an example design-time method executed by the computer system in FIG. 1.

FIG. 7 illustrates an example of navigating to a registered target web page of a web-based portal.

FIG. 8 illustrates an example of navigating to an unregistered target web page of a web-based portal.

FIG. 9 is a flowchart of an example run-time method executed by the computer system in FIG. 1.

Like reference symbols in the various drawings indicate like elements.

### DETAILED DESCRIPTION

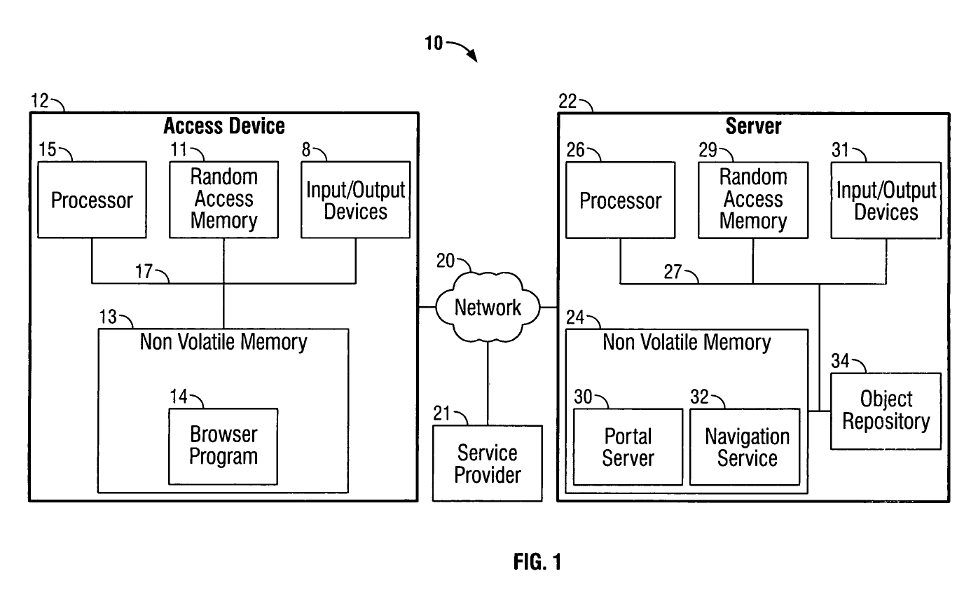

FIG. 1 illustrates a block diagram of a networked computer system 10 that allows for the display of web pages from a web-based portal. The system 10 includes a server 22 that includes a processor 26, a random-access memory 29, an input/output device 31, and a non-volatile memory 24, all of which are interconnected via a bus line 27 and controlled by the processor 26. The non-volatile memory 24 of the server 22 is configured to include a portal server 30 and a navigation service 32 that operate together to provide portal web pages to an access device 12.

Access device 12 also includes a processor 15, a random-access memory 11, an input/output device 8, and non-volatile memory 13 which are all interconnected via a bus line 17 and controlled by the processor 15. Non-volatile memory 13 of access device 12 is configured to include a browser program 14 for requesting and displaying information contained in web portals. The access device 12 also may be coupled to I/O devices that include a keyboard in combination with a pointing device such as a mouse for sending web page requests to server 22 over a network 20. A personal computer, cellular phone, personal digital assistants (‘PDAs’), and other mobile type devices capable of displaying portal web pages may be used as the access device 12.

The network 20 may include various devices such as servers, routers and switching elements connected in an intranet, extranet or Internet configuration. As described previously, the user may use access device 12 to access the server 22 over the network 20.

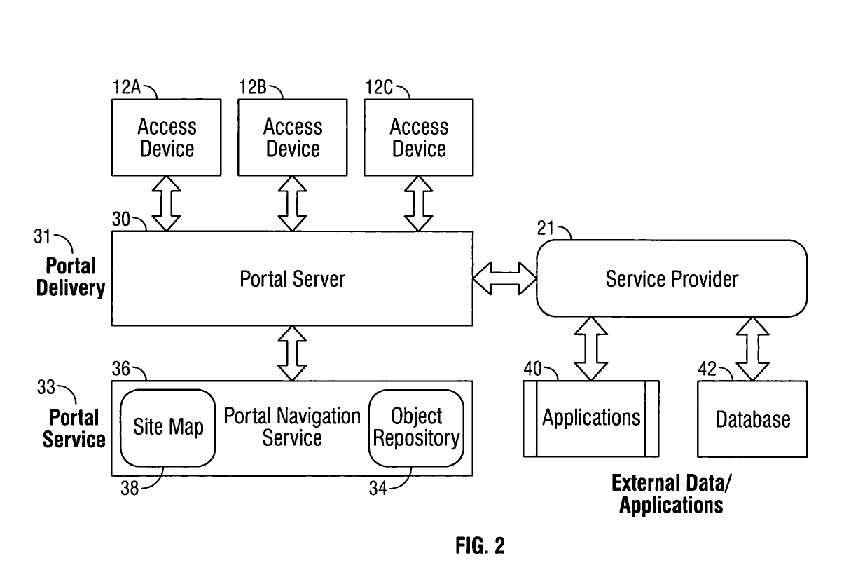

Referring to FIG. 2, an example architecture of a web-based portal is disclosed. The architecture provides a number of dimensions that allow for the integration of additional software components to support the needs of various organizations.

A portal delivery layer 31 is provided that includes the portal server 30 that receives web page requests from access devices 12a, 12b and 12c. The portal delivery layer 31 receives and responds to web page requests using one or more communications protocols, such as HTTP (Hypertext Transfer Protocol) over network 20. In one embodiment, the portal server 30 responds to web page requests by first requesting portal structure information and a target web page definition for the web page request from a portal service layer 33. The target web page definition provides a web page layout that includes the services/tiles that are defined for the requested web page and an identifier of the service provider 21 to be used for accessing web page content. Portal structure information provides information that allows the access device to emulate a selection from a portal navigation menu displayed on the access device. In one embodiment, applications 40 and external databases 42 are accessible to the service provider 21 to store and retrieve information, such as sales revenue and cost of goods sold, on an as needed basis. Once the portal server 30 receives the portal structure and target web page definition from the portal service layer 33, the portal server 30 instantiates the target web page using the service provider 21 and sends the instantiated web page and portal structure information to the requesting access device. In some embodiments, portal structure information also may include an identifier indicating the target web page definition used in instantiating the web page for display on the access device.

In some embodiments, the portal server 30 may receive a list of target web pages from the portal service layer 33 that meet the requested web page request. In such embodiments, the portal server 30 sends the list of target web pages to the access device for a selection from the list. In yet other embodiments, the portal service layer 33 may make a determination of which target web page to instantiate from the list of target web pages using the role of a user accessing the web portal.

The portal service layer 33 includes a portal navigation service 36 that provides portal structure definitions and target web page definitions to the portal server 30 for instantiation. In one embodiment, as shown in FIG.2, the portal navigation service 36 includes a sitemap 38 and an object repository 34 that are used by the portal navigation service 36 to identify target web page definitions and portal structure information in response to a request from portal server 30.

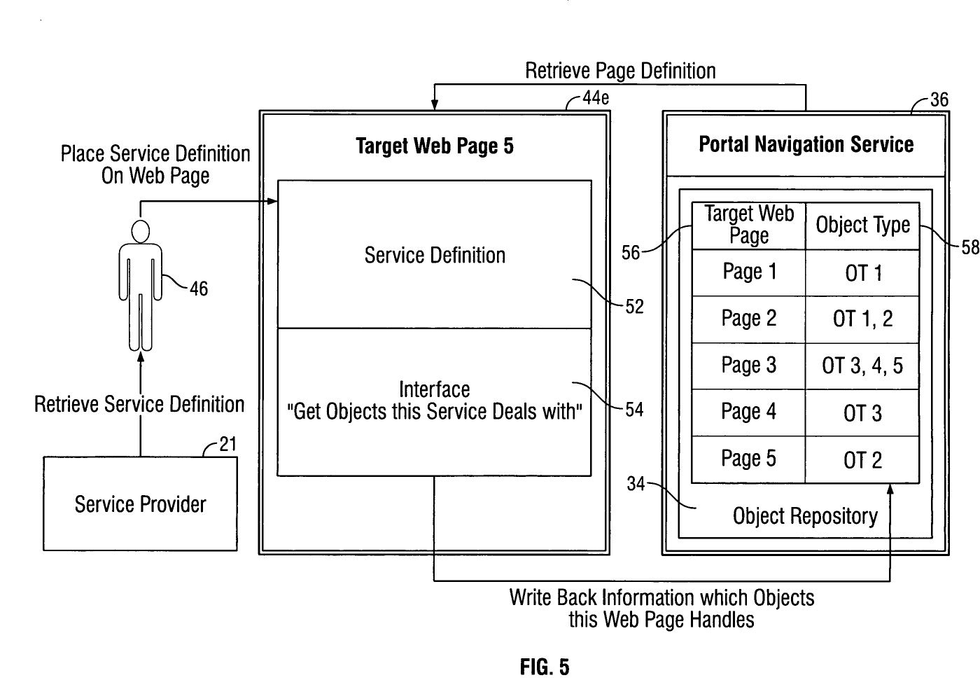

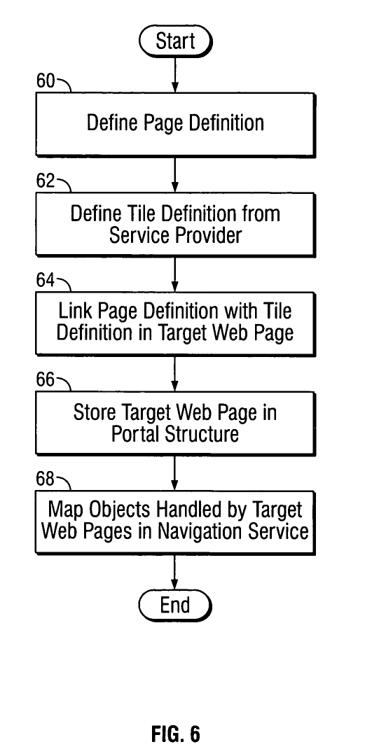

The sitemap 38 included in the portal navigation service 38 stores the arrangement of pre-defined target web pages accessible from the web portal. For each target web page defined, an object repository 34 is provided that stores the types of objects/services each target web page can provide. For example, a target web page may include an object/service that accesses sales revenue information and another object/service that accesses costs of goods sold information. Assigning object/services to target web pages is disclosed in FIGS. 5 and 6.

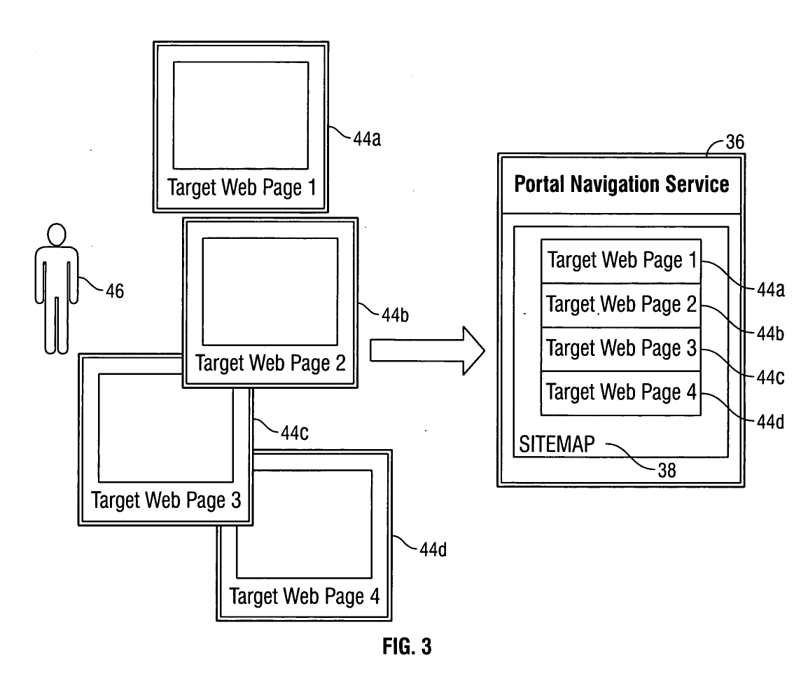

FIG. 3 illustrates an example of defining target web pages for a web-based portal. As shown in FIG. 3, one or more target web pages 44a-44d can be designed by an administrator 46 and stored in a sitemap 38. Typically, the process includes designing a page definition (layout) for the target web page and accessing a service definition from a service provider. Once the administrator assembles the page definition and service definition for the target web page, the target web page is stored in the sitemap 38. The process of defining target web pages is well known in the art.

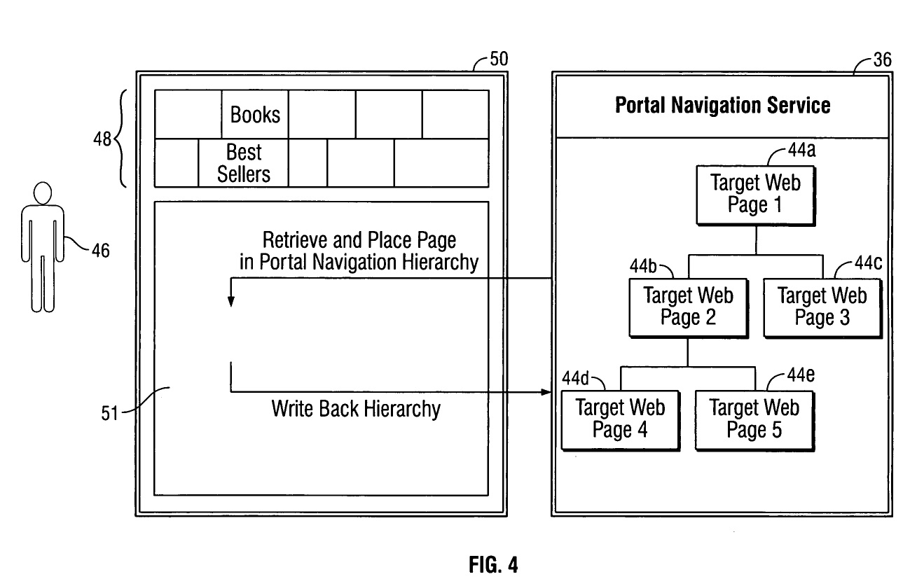

FIG. 4 illustrates an example of defining the structure of target web pages for a web-based portal. As shown in FIG. 4, portals provide a navigation menu 48 that can be used by users to access target web pages. Typically, the navigation menu 48 is arranged in a logical sequence of user selectable push buttons that once selected, initiate requests for web pages from access devices. Once the target web pages have been defined and stored in the sitemap 38, the administrator 46 retrieves the target web pages from sitemap 38 and establishes a link 51 between the target web page and a menu option included in the navigation menu 48. Once the link is established, the link is written back to the sitemap 38 and stored as portal structure information.

FIG. 5 illustrates an example of assigning services to target web pages. As shown in FIG. 5, at design time the administrator 46 retrieves the target web page definition from the sitemap 38 included in the portal navigation service 36. Once retrieved, the administrator establishes a link between the page and the service located on the page. This relationship is written back to the portal navigation service and is stored as page structure information. In one embodiment, if there are multiple services included on a target web page, an algorithm is provided that determines the ordering and arrangement of services relating to the target web page.

Once the target web page is stored back to the sitemap 38, the portal navigation service 36 automatically executes an interface named “Get_objects_this_service_deals_with” 54. The interface 54 identifies the names of objects/services defined for the target web page. As shown in FIG. 5, once the portal navigation executes the interface 54, a target web page identifier 56 representing the stored target web page and an object type 58 representing the objects/services provided by the target web page are stored in an object repository 34 residing in the portal navigation service 36. Once this process is complete, the target web page is registered with the portal navigation service 36.

FIG. 6 is a flow chart of steps that are carried out to design target web pages. As described previously, step 60 includes defining a web page definition. Defining a page definition includes defining a layout for the presentation (e.g., location, font type, font size, etc.) of data content displayed by the web page. In step 62, a service definition is established by retrieving an ID from a service provider that can be invoked to generate data content. In step 64, the page definition and service definition are linked together to represent a target web page definition. In step 66, the target web page definition and portal structure information are stored 66 in the sitemap 38. Lastly, the portal navigation service 36 stores a target web page identifier 56 representing the stored target web page and one or more object types 58 representing the objects/services provided by the target web page 68 in an object repository 34. The object repository 34 provides the portal navigation service 36 with a mapping of target web pages and services during run-time.

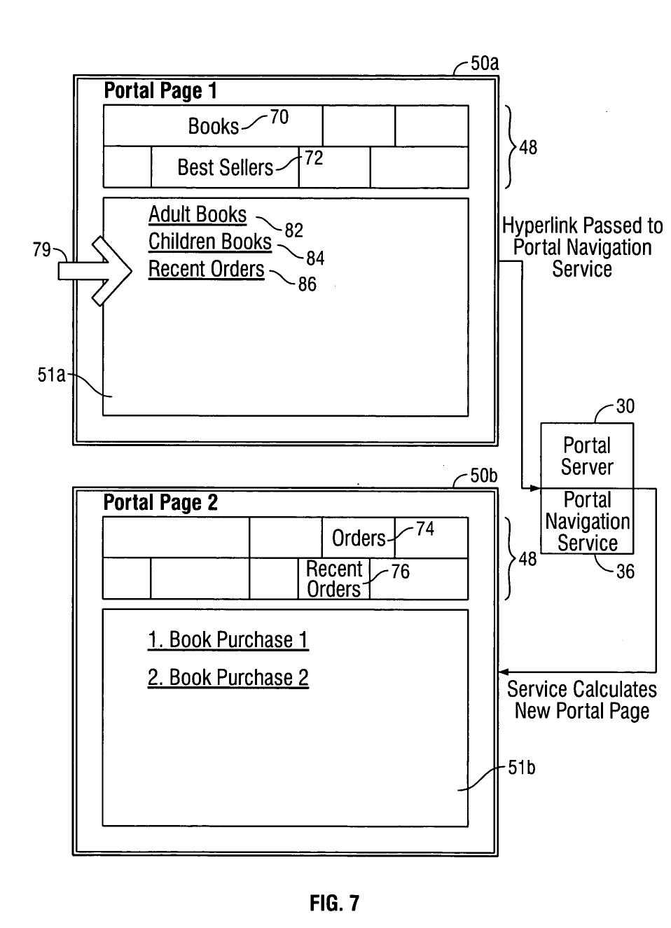

FIG. 7 illustrates an example of navigating to a registered target web page stored in a web-based portal using the browser program 14 of access device 12. As shown in FIG. 7, a first portal page 50a and a second portal page 50b are illustrated. Each of the portal pages 50a and 50b include a navigation menu 48 that includes a set of user-selectable navigation options arranged in a logical sequence. Selection of any one of the user-selectable navigation options sends a request to server 22 to display a web portal page. For example, referring to portal page 50a, selection of the navigation option entitled “Books” 70 followed by selection of the navigation option entitled “Best Sellers” 72 on the first portal page 50a displays an instantiated web page 51a. The instantiated web page 51a includes three hyperlinks entitled “Adult Books” 82, “Children Books” 84 and “Recent Orders” 86. In this example, for each of the hyperlinks displayed on the instantiated web page 51a, the hyperlink leads to an existing target web page definition stored within the web portal. For example, as shown in FIG. 7, the hyperlink entitled “Recent Orders” 86 is also represented as a navigation option accessible from navigation menu 48 on the first portal page 50a.

Upon user selection 79 of the “Recent Orders” hyperlink 86, a web page request is sent to the portal server 30 as described previously. The portal server 30, in turn, requests the portal navigation service 36 to provide portal structure information and the target web page definition for the web page request. The portal navigation service 36 then determines if any target web page included in the web portal provides the object/service being requested by querying the object repository 34 by object type 58. If there is a target web page identifier in the object repository that includes the requested service, the portal navigation service 36 uses the target web page identifier 56 to accesses the target web page definition and portal structure information stored in the sitemap 38 and sends the same to the portal server 30 for instantiation.

Once the target web page is instantiated, the instantiated web page 51b, as shown in FIG. 7, is sent to the access device and rendered by browser program 14 in the second portal page 50b. Portal structure information is also sent to the browser program 14 to cause the navigation menu 48 displayed on portal page 50b to emulate user-selections of navigation options. As shown in FIG. 7, the portal structure information provided by the portal navigation service 36 causes the browser program 14 to emulate a user-selection of the navigation options entitled “Orders” 74 and “Recent Orders” 76 which are linked to the instantiated web page.

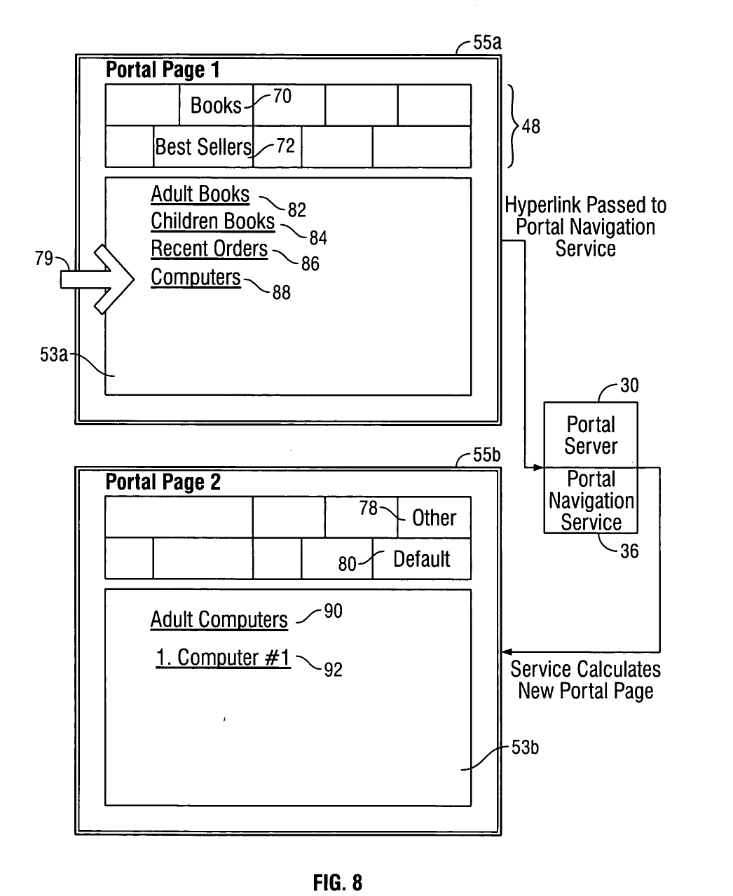

FIG. 8 illustrates an example of navigating to an unregistered web page using a web-based portal. Similar to FIG. 7, a first portal page 55a and a second portal page 55b are illustrated. Each of the portal pages 55a, 55b include navigation menus that include user-selectable navigation options. Selection of the navigation options entitled “Books” 70 followed by selection of the navigation option entitled “Best Sellers” 72 on the first portal page 55a displays an instantiated web page 53a. The instantiated web page 53a includes four hyperlinks entitled “Adult Books” 82, “Children Books” 84, “Recent Orders” 86, and “Computers” 88. In contrast to FIG. 7, however, the hyperlinks provided on the instantiated web page 53a do not necessarily lead to an existing target web page definition stored within the web portal. For example, as shown in FIG. 8, the hyperlink entitled “Computers” 88 is not represented as a navigation option accessible from navigation menu 48 on the first portal page 55a.

Upon user selection 79 of the “Computers” hyperlink 88, a web page request is sent to the portal server 30 as described previously. The portal server 30, in turn, requests the portal navigation service 36 to provide portal structure information and the target web page definition for the web page request. If no target web page identifier exists in the object repository 34 that is associated with the requested service, the portal navigation service 36 accesses a default target web page definition and related portal structure information stored in the sitemap 38 and sends the same to the portal server 30 for instantiation. Portal structure information is also sent to the browser program 14 to cause the navigation menu 48 displayed on portal page 50b to emulate user-selections of navigation options. As shown in FIG. 8, the portal structure information provided by the portal navigation service 36 causes the browser program 14 to emulate a user-selection of the navigation options entitled “Other” 78 and “Default” 80 which are linked to the default web page 53b.

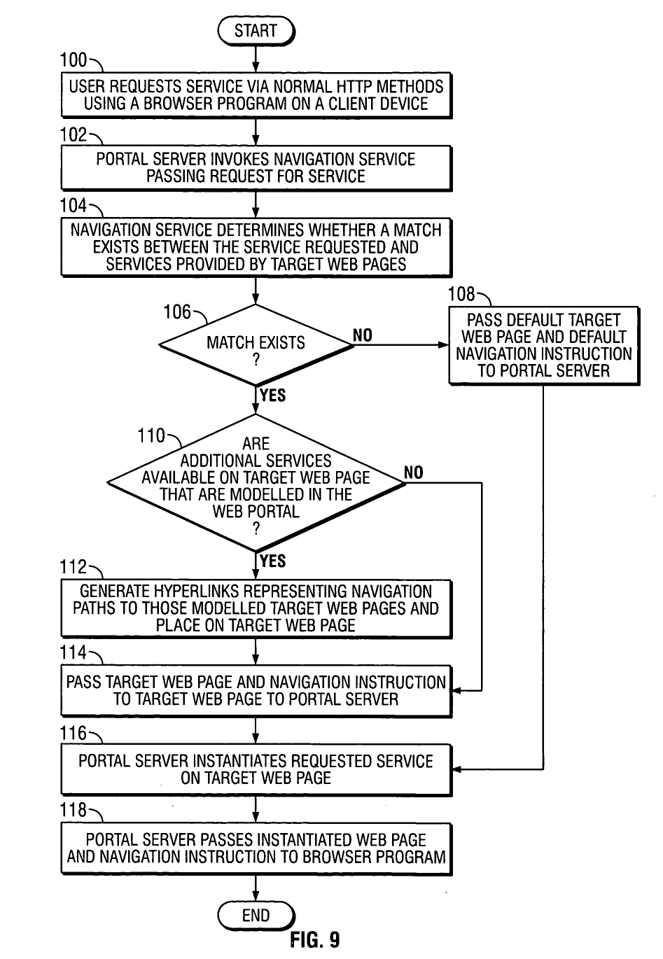

FIG. 9 is a flowchart of an example run-time method executed by the computer system in FIG. 1. Referring to FIG. 1 and 9, step 100 involves a user requesting a target web page using browser program 14 executing on access device 12. The request for information can be generated in various ways, such as by the activation of a hyperlink, by control functions provided by a portal, by typing a page address into an address field, as well as by activating the “back” button of the browser window. Next, in step 102, the portal server 30 receives the request and invokes portal navigation service 36 passing to it the request for a service. In step 104, the portal navigation service determines 36 whether a match exists between the service requested and services provided by target web pages in the web portal. If a match does exist 106, the portal navigation service 36 next determines whether additional services available on the identified target web page exist in the web portal 110. If additional services do exist in the web portal that are included in the identified target web page, the portal navigation service generates hyperlinks representing navigation paths to those target web pages and places these generated hyperlinks on the target web page 112. Regardless of whether additional services are or are not available on the identified target web page that is identified, the portal navigation service 36 sends the identified target web page definition and portal structure information to the portal server 114. Lastly, the portal server 30 instantiates the requested service on the target web page 116 and passes the instantiated web page and portal structure information 118 to the browser program 14 for rendering on access device 12.

In the event the portal navigation service 36 determines that a match does not exist between a service requested and the target web pages stored in the web portal 106, the portal navigation service sends a default target web page and portal structure information for the default target web page to the portal server 108 for instantiation 116. Lastly, the portal server 30 instantiates the requested service on the target web page 116 and passes the instantiated default web page and portal structure information 118 to the browser program 14 for rendering on access device 12.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A number of embodiments of the invention have been described. Nevertheless, it will be understood that various modifications may be made without departing from the spirit and scope of the invention. For example, the modules described above may be organized or contained in various ways, and may reside on multiple computers. Also, the steps described above may be modified in various ways or performed in a different order than described above, where appropriate. Accordingly, other embodiments are within the scope of the following claims.

1. A method of displaying a portal page registered within a web-based portal that includes portal pages registered within a web-based architecture and navigation options linked to different ones of the registered portal pages, the method comprising:
providing, from a server and to an access device, information to provide a display of a selected first registered portal page that includes a hyperlink to a second registered portal page, wherein the display is provided within a displayed navigation framework that includes a navigation menu for user selection of navigation options;
receiving, at the server, an input indicating user selection of the displayed hyperlink to the second registered portal page;
providing, from the server to the access device, 1) information to provide a display of the second registered portal page within the displayed navigation framework, and 2) information that causes the navigation menu to emulate a selection of a navigation option linked to the second registered navigation page.

2. The method of claim 1 wherein the information that causes the navigation menu to emulate the selection of the navigation option linked to the second navigation option includes a display indicator describing the target web page to be displayed.

3. The method of claim 1 further comprising processing the input received from the access device by identifying a registered target web page from a plurality of target web pages existing in the displayed navigation framework.

4. The method of claim 3 wherein processing the input comprises parsing the input for at least one service request, the at least one service request identified in the target web pages included in the displayed navigation framework.

5. The method of claim 4 wherein processing the input comprises:
transmitting a selectable list of target web pages in response to the input, the selectable list of target web pages identifying a plurality of target web pages that include a service matched to the at least one service request; and
processing one of the selectable list of target web pages based on a selection from the selectable list.

6. The method of claim 3 wherein processing the input comprises selecting one of the plurality of target web pages included in the portal framework using a user role.

7. A method of displaying a portal page registered within a portal structure that includes portal pages registered within the portal structure and navigation options linked to different ones of the registered portal pages, the method comprising:
providing, from a server and to an access device, information to provide a display of a selected first registered portal page that includes a hyperlink to an unregistered portal page, wherein the display is provided within a displayed navigation framework that includes a navigation menu for user selection of navigation options;
receiving, at the server, an input indicating user selection of the displayed hyperlink;
providing, from the server to the access device, 1) information to provide a display of the selected unregistered web page, and 2) information that causes the navigation menu to emulate a selection of a navigation option linked to a default navigation page.

8. The method of claim 7 wherein the information that causes the navigation menu to emulate the selection of the navigation option linked to the default navigation option includes a display indicator describing the default navigation page to be displayed.

9. The method of claim 7 further comprising processing the input received from the access device by identifying a default navigation page from a plurality of target web pages existing in the displayed navigation framework.

10. The method of claim 7 wherein processing the input comprises parsing the input for at least one service request, the at least one service request not identified with the target web pages included in the displayed navigation framework.

11. A method used in generating a portal page to be registered within a portal structure that includes portal pages registered within a portal framework and navigation options linked to different ones of the registered portal pages, the method comprising:
assigning, for a portal page being generated, a service to be included in the portal page, the service represented within a service definition of the portal page; and
registering the portal page being generated and the service included in the portal page being generated with a portal navigation service, the portal navigation service upon receipt of a request that includes a service name identifying the generated portal page.

12. The method of claim 11 wherein registering the portal page being generated and the service included in the portal page with the run-time service occurs upon storage of the portal page in a navigation framework.

13. A computer program product tangibly embodied in an information carrier, the computer program product for displaying a portal page registered within a web-based architecture and navigation options linked to different ones of the registered portal pages, and the computer program product including instructions that, when executed, cause a processor to perform operations comprising:
provide, from a server and to an access device, information to provide a display of a selected first registered portal page that includes a hyperlink to a second registered portal page, wherein the display is provided within a displayed navigation framework that includes a navigation menu for user selection of navigation options; and
in response to receipt, at the server, of an input indicating user selection of the displayed hyperlink to the second registered portal page, provide, from the server to the access device, 1) information to provide a display of the second registered portal page within the displayed navigation framework, and 2) information that causes the navigation menu to emulate a selection of a navigation option linked to the second registered navigation page.

14. The computer program product of claim 13, wherein the operations further comprise:
include a display indicator describing the target web page to be displayed in the information that causes the navigation menu to emulate the selection of the navigation option linked to the second navigation option.

15. The computer program product of claim 13, wherein the operations further comprise:
process the input received from the access device by identifying a registered target web page from a plurality of target web pages existing in the displayed navigation framework.

16. The computer program product of claim 15, wherein the operations further comprise:
parse the input for at least one service request, the at least one service request identified in the target web pages included in the displayed navigation framework.

17. The computer program product of claim 16, wherein the operations further comprise:
transmit a selectable list of target web pages in response to the input, the selectable list of target web pages identifying a plurality of target web pages that include a service matched to the at least one service request; and
process one of the selectable list of target web pages based on a selection from the selectable list.

18. The computer program product of claim 15, wherein the operations further comprise:
select one of the plurality of target web pages included in the portal framework using a user role.

19. A computer program product tangibly embodied in an information carrier, the computer program product for displaying a portal page registered within a web-based architecture and navigation options linked to different ones of the registered portal pages, and the computer program product including instructions that, when executed, cause a processor to perform operations comprising:
provide, from a server and to a access device, information to provide a display of a selected first registered portal page that includes a hyperlink to an unregistered portal page wherein the display is provided within a displayed navigation framework that includes a navigation menu for user selection of navigation options; and
in response to receipt, at the server, of an input indicating user selection of the displayed hyperlink to the unregistered portal page,
provide, from the server to the access device, 1) information to provide a display of the selected unregistered web page, and 2) information that causes the navigation menu to emulate a selection of a navigation option linked to a default navigation page.

20. The computer program product of claim 19, wherein the operations further comprise:
include a display indicator describing the target web page to be displayed in the information that causes the navigation menu to emulate the selection of the navigation option linked to the second navigation option.

21. The computer program product of claim 20, wherein the operations further comprise:
process the input received from the access device by identifying a default navigation page from a plurality of target web pages existing in the displayed navigation framework.

22. The computer program product of claim 19, wherein the operations further comprise:
parse the input for at least one service request, the at least one service request not identified with the target web pages included in the displayed navigation framework.

23. A computer program product tangibly embodied in an information carrier, the computer program product for creating a portal page registered within a web-based architecture and navigation options linked to different ones of the registered portal pages, and the computer program product including instructions that, when executed, cause a processor to perform operations comprising:
assign, for a portal page being generated, a service to be included in the portal page, the service represented within a service definition of the portal page; and
register the portal page being generated and the service included in the portal page being generated with a portal navigation service, the portal navigation service upon receipt of a request that includes a service name identifying the generated portal page.

24. The computer program product of claim 23, wherein the operations further comprise:
store the portal page in a navigation framework.
